(19) United States
(12) Patent Application Publication
(10) Pub. No.: US 2008/0304510 A1
(43) Pub. Date: Dec. 11, 2008

(54) METHOD AND APPARATUS FOR CONTROLLING RADIO CONNECTION BASED ON INPUTS FROM APPLICATIONS

(76) Inventor: Hai Qu, San Diego, CA (US)

Correspondence Address: QUALCOMM INCORPORATED, 5775 MOREHOUSE DR., SAN DIEGO, CA, 92121, US

(21) Appl. No.: 11/760,671

(22) Filed: Jun. 8, 2007

(51) Int. Cl. H04L 12/24; H04B 7/204

(52) U.S. Cl. 370/463

(57) ABSTRACT

Techniques for detecting end of activity and controlling a radio connection are described. In one design, inputs may be received from at least one application exchanging data with a wireless communication network via a radio connection. Whether to maintain or close the radio connection may be determined based on the inputs from the application(s). In another design, flow preferences may be received from at least one application for data flows. The states of the data flows may be determined based on their flow preferences and inputs from the application(s). A data flow may be determined to be active or inactive based on its flow preference, inputs received from an application for the data flow, activity detected on the data flow, etc. Whether to maintain or close a radio connection may be determined based on the states of the data flows. The radio connection may be closed when all data flows are inactive.

### BACKGROUND

I. Field

The present disclosure relates generally to communication, and more specifically to techniques for controlling a radio connection in wireless communication.

II. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A user may utilize an access terminal (e.g., a cellular phone) to obtain one or more communication services (e.g., voice, data connectivity, etc.) from a wireless network. The access terminal may establish a radio connection with the wireless network and may be allocated radio and other resources for the radio connection. The access terminal may thereafter exchange data with the wireless network via the radio connection to obtain the desired communication service(s).

For each service, data may be exchanged at regular intervals or at sporadic times. For example, a voice service may exchange data periodically every 20 milliseconds (ms) or at some other interval. A packet data service may exchange data sporadically whenever there is data to send and may not have any activity for an extended period of time. It is desirable to close the radio connection as soon as activities for all of the service(s) ended. This may then free up valuable resources allocated for the radio connection so that the resources may be used for other access terminals. However, determining whether or not to close the radio connection may be challenging, e.g., if multiple services are obtained and/or if data is sent sporadically.

There is therefore a need in the art for techniques to detect for end of activity so that the radio connection may be closed as soon as possible.

### SUMMARY

Techniques for detecting end of activity and controlling a radio connection are described herein. In one design, inputs may be received from at least one application exchanging data with a wireless communication network via a radio connection. Whether to maintain or close the radio connection may be determined based on the inputs from the at least one application.

In another design, flow preferences may be received from at least one application for data flows, which may include SIP flows, RTP flows, etc. The flow preferences may include (i) a flow preference to maintain a data flow until it is explicitly released, (ii) a flow preference to release a data flow after an idle time, (iii) a flow preference to release a data flow as soon as a service transaction is completed, and/or (iv) other flow preferences. The states of the data flows may be determined based on their flow preferences and inputs from the at least one application. For example, a data flow may be determined to be active or inactive based on its flow preference, flow directives and/or transaction status received from an application for the data flow, activity detected on the data flow, etc. Whether to maintain or close a radio connection may be determined based on the states of the data flows. For example, the radio connection may be closed when all of the data flows are determined to be inactive.

Various aspects and features of the disclosure are described in further detail below.

### BRIEF DESCRIPTION OF THE DRAWINGS

FIG. 1 shows a wireless communication network.

FIG. 2 shows flows at various layers for an access terminal.

FIG. 3 shows an example of detection for end of activity for three data flows.

FIG. 4 shows a design of a data flow information table.

FIG. 5 shows a design of a module that detects for end of activity and controls the radio connection based on inputs from applications.

FIG. 6 shows a process for controlling the radio connection.

FIG. 7 shows another a process for controlling the radio connection.

FIG. 8 shows a block diagram of the access terminal.

### DETAILED DESCRIPTION

The techniques described herein may be used for various wireless communication networks. The terms “network” and “system” are often used interchangeably. For example, the techniques may be used for CDMA, TDMA, FDMA, OFDMA, and SC-FDMA networks. A CDMA network may implement a radio technology such as cdma2000, Universal Terrestrial Radio Access (UTRA), Evolved UTRA (E-UTRA), etc. cdma2000 covers IS-2000, IS-95 and IS-856 standards. UTRA includes Wideband-CDMA (W-CDMA) and Time Division-Synchronous CDMA (TD-SCDMA). A TDMA network may implement a radio technology such as Global System for Mobile Communications (GSM), Digital Advanced Mobile Phone System (D-AMPS), etc. An OFDMA network may implement a radio technology such as Long Term Evolution (LTE) (which is part of E-UTRA), IEEE 802.20, Flash-OFDM®, etc. These various radio technologies and standards are known in the art. UTRA, E-UTRA, GSM and LTE are described in documents from an organization named “3rd Generation Partnership Project” (3GPP). cdma2000 is described in documents from an organization named “3rd Generation Partnership Project 2” (3GPP2). 3GPP and 3GPP2 documents are publicly available.

For clarity, certain aspects of the techniques are described for a High Rate Packet Data (HRPD) network that implements IS-856. HRPD is also referred to as CDMA2000 1xEV-DO, 1xEV-DO, 1x-DO, DO, High Data Rate (HDR), etc.

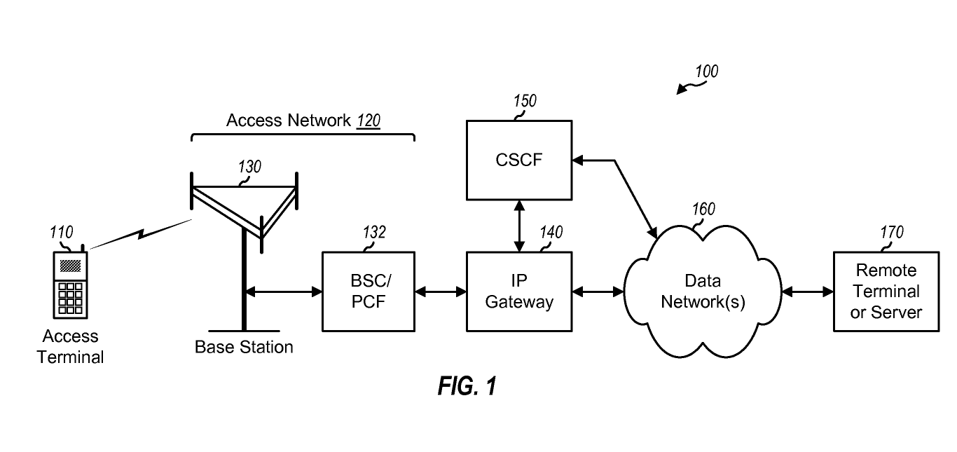

FIG. 1 shows a wireless communication network 100, which may be an HRPD network. Wireless network 100 includes (i) an access network 120 that supports radio communication for access terminals and (ii) network entities that perform various functions to support communication services. An access network may also be referred to as a radio network, a radio access network, etc. Access network 120 may include any number of base stations 130 and any number of Base Station Controllers/Packet Control Functions (BSCs/PCFs) 132. A base station is generally a fixed station that communicates with the access terminals and may also be referred to as an access point, a Node B, an evolved Node B (eNode B), etc. BSC/PCF 132 couples to a set of base stations, provides coordination and control for the base stations under its control, and routes data for these base stations.

An Internet Protocol (IP) gateway 140 supports data services for access terminals communicating with access network 120. For example, IP gateway 140 may be responsible for establishment, maintenance, and termination of data sessions for access terminals and may further assign dynamic IP addresses to the access terminals. IP gateway 140 may communicate with other network entities to support the data services. IP gateways 140 may couple to data network(s) 160, which may comprise a core network, private data networks, public data networks, the Internet, etc. IP gateway 140 can communicate with various entities such as a remote terminal or server 170 via data network(s) 160. IP gateway 140 may also be referred to as a Packet Data Serving Node (PDSN). A Call Session Control Function (CSCF) 150 performs various functions to support IP Multimedia Subsystem (IMS) services such as Voice-over-IP (VoIP), multimedia, etc. For example, CSCF 150 may process requests from access terminals for IMS services, perform registration for IMS, provide session control services, maintain session state information, etc. Wireless network 100 may include other network entities not shown in FIG. 1.

An access terminal 110 may communicate with access network 120 to obtain various communication services supported by wireless network 100. Access terminal 110 may also be referred to as a mobile station, a user equipment, a user terminal, a subscriber unit, a station, etc. Access terminal 110 may be a cellular phone, a personal digital assistant (PDA), a wireless modem, a handheld device, a laptop computer, etc. Access terminal 110 may communicate or exchange data with other access terminals, remote terminal or server 170, and/or other entities via access network 120.

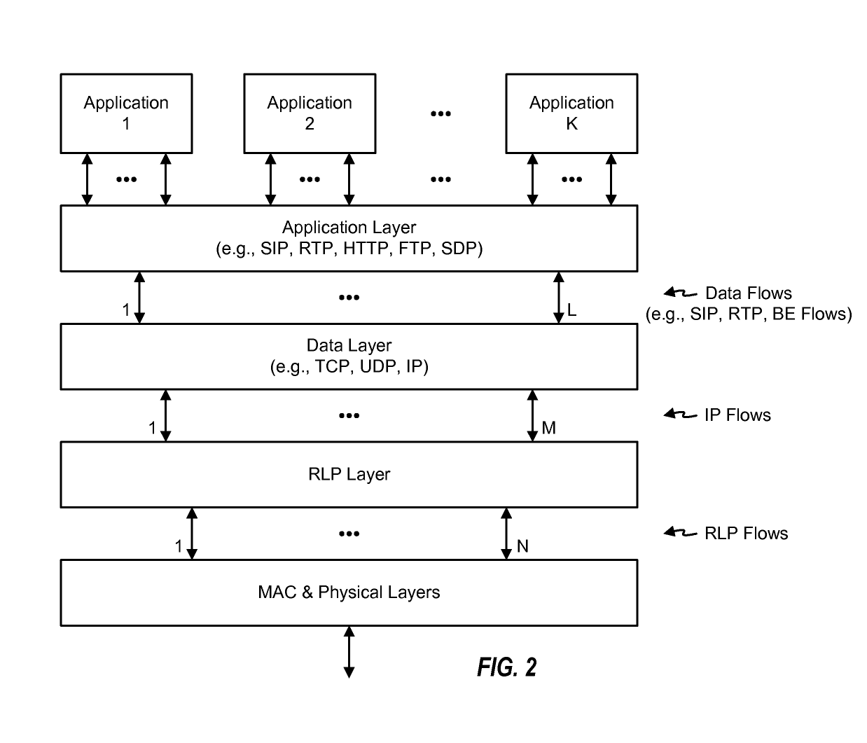

FIG. 2 shows flows at various layers for access terminal 110. Access terminal 110 may have K active applications that may engage any communication services from wireless network 100, where K may be any number greater than zero. The K applications may be for VoIP, video, video conferencing, Short Message Service (SMS) over IP, Instant Messaging (IM), SMS over IM, video share, push-to-talk (PTT), etc. Some of these applications are defined in 3GPP IMS and 3GPP2 Multimedia Domain (MMD). The K applications may have traffic that belongs in different classes such as conversational, streaming, interactive, and background. The conversation class may cover delay sensitive applications such as VoIP, video, video conferencing, etc. The streaming class may cover data rate sensitive applications such as video streaming, audio streaming, web casting, etc. The interactive class may be characterized by a request/response traffic pattern and may cover applications such as web browsing. The background class may be characterized by a relatively insensitive delivery time and may cover applications such as email download. Traffic data for applications in the interactive and background classes may be sent in best effort (BE) flows. Traffic data for applications in the conversation and streaming classes may be sent in flows having certain quality of service (QoS) requirements.

The K applications may communicate with other entities (e.g., remote terminal or server 170) using Session Initiation Protocol (SIP), Real-time Transport Protocol (RTP), Session Description Protocol (SDP), HyperText Transfer Protocol (HTTP), File Transfer Protocol (FTP), and/or other protocols at an application layer. SIP is a signaling protocol for creating, modifying, and terminating sessions for VoIP, multimedia, etc. RTP provides end-to-end network transport functions and is suitable for applications sending real-time data such as voice, video, etc. SDP is a signaling protocol for describing multimedia sessions. HTTP supports transfer of information on the World Wide Web and is commonly used to publish and retrieve HTLM pages. FTP supports transfer of files between two terminals and is commonly use to download data, files, etc.

Each application may have any number of data flows. A data flow may be a SIP flow, an RTP flow, a best effort (BE) flow, etc. Each data flow may be associated with a different port number at a transport layer. In general, a data flow may carry any type of data (e.g., traffic data, signaling data, etc.) and may also be referred to as a traffic flow, a signaling flow, etc. For example, a VoIP application may have one or more RTP flows for traffic data and a SIP flow for signaling data. The K applications may have a total of L data flows, where L may be any number greater than zero.

The L data flows may be processed by a data layer and mapped to M IP flows, where M may be any number greater than zero. The data layer may include Transmission Control Protocol (TCP), User Datagram Protocol (UDP), IP and/or other protocols. Each data flow may be mapped to a suitable IP flow, and each IP flow may carry any number of data flows. For example, access terminal 110 may have one or two IP flows to carry RTP and SIP flows for a VoIP application and may have another IP flow to carry a best effort flow for a browser application.

The M IP flows may be processed by an RLP layer and mapped to N RLP flows, where N may be any number greater than zero. An RLP flow is also referred to as an RLP instance. In HRPD, access network 120 may grant QoS for RLP flows (instead of IP flows or data flows). The desired QoS for a given RLP flow may be specified by a set of QoS parameters, which is referred to as a QoS profile.

The K applications may have certain QoS requirements. Access terminal 110 may determine one or more QoS profiles that can satisfy the QoS requirements of all of the applications. Access terminal 110 may then request one or more RLP flows for the one or more QoS profiles, one RLP flow for each QoS profile. Access terminal 110 may then map each data flow to an IP flow and map each IP flow to an RLP flow that can satisfy the QoS requirements (if any) for the data flow(s) sent in the RLP flow. Each RLP flow may carry any number of data flows whose QoS requirements can be satisfied by the QoS profile granted for that RLP flow. For example, one RLP flow may carry SIP flows for one or more applications, another RLP flow may carry RTP flows for VoIP and/or other applications, yet another RLP flow may carry best effort flows for one or more applications, etc.

The N RLP flows may be processed by Medium Access Control (MAC) and physical layers and mapped to one or more traffic channels. Access terminal 110 may have established a radio connection with access network 120 and may be assigned one or more traffic channels, a MAC identifier (MACID), and/or other resources. Access terminal 110 may send data via the assigned traffic channel(s) using the assigned MACID. The resources may be assigned to access terminal 110 during establishment of the radio connection, which may take some amount of time in order to negotiate various parameters for the RLP flows and radio connection. The resources are typically assigned to access terminal 110 for as long as the radio connection remains up.

The description above is for processing of flows for reverse link (or uplink) transmission from access terminal 110 to access network 120. A flow may carry traffic data and/or signaling data for the reverse link direction as well as the forward link (or downlink) direction from access network 120 to access terminal 110.

The K applications may engage any communication services and may have different traffic patterns and requirements for the radio connection. For example, a VoIP application may exchange data periodically (e.g., every 20 ms) and may desire to have the radio connection remains up for the duration of the VoIP session so that the response time for data exchanges between the access terminal and the access network is satisfactory to the end user. If the radio connection is established and closed often during the VoIP session, then the user may experience excessive delays frequently. Conversely, an application may desire to have the radio connection up for a particular transaction, e.g., to send an SMS message. In this case, the radio connection may be closed when the transaction is completed and no other active applications are running. In general, it is desirable to close the radio connection as soon as activities for all of the services ended and the radio connection is not needed by any of the applications. However, detecting for end of activity may not be trivial because (i) different applications may have different traffic patterns and (ii) the data flows for the applications may be mapped to RLP flows in a flexible manner.

In an aspect, the radio connection may be controlled based on inputs from the applications such that delay requirements of all applications may be satisfied and the radio connection may be closed as quickly as possible. The applications may provide various types of inputs that may be used for management of the data flows and the radio connection. In one design, the applications may provide the following inputs:
Flow preference—indicate how a data flow should be maintained,
Flow directive—request to set up or release a data flow,
Connection directive—request to establish or close the radio connection, and
Transaction status—indicate the status of a transaction for a data flow.
   Different and/or other types of inputs may also be supported.

In one design, the following flow preferences may be supported:
Explicit release (or maintain until explicit release)—a data flow should be maintained until it is explicitly released,
Idle release (or release after an idle time)—a data flow may be released if there is no activity on the data flow for a predetermined amount of time, and
Immediate release—a data flow may be released immediately after a transaction.
   Other flow preferences may also be supported.

Different applications may have different flow preferences, which may be selected based on traffic patterns, delay requirements, and/or other characteristics of the applications. The explicit release preference may be used by session-based applications (e.g., VoIP, audio streaming, video streaming, etc.) that may exchange data throughout a session. The explicit release preference may also be used by delay sensitive applications, connection state sensitive applications, and emergency sessions such as E911 VoIP call. The idle release preference may be used by transaction-based applications (e.g., SMS over IP) that may have sporadic transactions. The immediate release preference may be used by transaction-based applications in which a single transaction is expected.

An application may also use the explicit release preference for a given data flow in order to reduce the number of times the data flow is set up and released. For example, the application may reuse the same data flow for sending and receiving many transaction-based messages, even if these messages do not require any sessions. This may then eliminate or reduce the number of times the data flow (and possibly the radio connection) is set up and released for exchanging the messages.

An application may have one or more data flows and may select a suitable flow preference for each data flow. The application may provide the selected flow preference for each data flow when the application is first launched, when the data flow is set up, etc. The application may also dynamically change the flow preference for a given data flow based on changes in traffic pattern and/or requirements of that data flow. For example, an Instant Messaging application may initially desire to maintain a SIP flow during a chat session and may select the explicit release preference when the SIP flow is first set up. The Instant Messaging application may thereafter desire to release the SIP flow after an idle time if no messages are sent in the chat session and may then select the idle release preference for the SIP flow.

An application may provide an idle timer value for each data flow with the idle release preference. The idle timer value for each data flow may be selected based on expected activity, data requirements, and/or relative importance of that data flow. For example, a short idle timer value may be used for a data flow in which relatively non-critical data is expected in a short time. Conversely, a long idle timer value may be used for a SIP flow carrying relatively important signaling data, a data flow in which data is expected but with possibly long delay, etc. The idle timer value for a data flow may also be changed at any time.

In one design, the following connection directives may be supported:
Advance connection request—a request to establish the radio connection, if it is not already up, prior to a data flow being set up, and
Close connection request—a request to close the radio connection.
   Other connection directives may also be supported.

An application may send an advance connection request to establish the radio connection prior to commencement of a session or any transaction on a data flow. The advance connection request may be used to improve response time for certain applications and/or certain scenarios. For example, a push-to-talk application may desire to establish the radio connection first and then engage in one or more push-to-talk sessions. As another example, an SMS application may desire to establish the radio connection when the user starts typing so that a message may be sent as soon as the user completes the message. A data flow may also be set up in response to the advance connection request or may be set up some time after the radio connection has been established.

An advance connection request may be generated in various manners. For example, an advance connection request may be generated in response to user typing activity, user scrolling through menus on the access terminal, user taking pictures with a built-in camera on the access terminal, and/or other user actions. The advance connection request may also be generated based on information on past user activities and habits. For example, history information may indicate good likelihood of sending an SMS message whenever the user types S characters or more, where S may be any value. In this case, an advance connection request may be generated whenever at least S characters have been typed.

An application may send a close connection request to request closing of the radio connection. The close connection request may be used to explicitly release data flows with the explicit release preference. The close connection request may also be used to immediately release data flows with the idle release preference, instead of having to wait for the idle timers for these data flows to expire. The close connection request may also be generated, e.g., in response to the user pressing an END key or closing a flip phone, and used to end all pending sessions immediately. The close connection request may also be asserted, e.g., in response to the user switching the phone to a special mode so that no radio connection will be active in order to conserve battery power when no services are desired.

In one design, the following transaction status may be supported:
Started—a transaction is started and pending, and
Completed—a transaction is completed.
   Other transaction statuses may also be supported.

The transaction status may be used to start and cancel the idle timers for data flows with the idle release preference. If a data flow has the idle release preference, then the idle timer for the data flow may be (i) started when a completed transaction status is received for the data flow and (ii) canceled when a started transaction status is received for the data flow. If a data flow has the explicit release preference, then the data flow may be released immediately when a release flow request is received for the data flow or a connection release request is received. However, the transaction status may be recorded for this data flow in case its flow preference changes later. The transaction status may also be used in other manners to determine when to release the data flow. The idle timer for a given data flow may be started and canceled based on the transaction status and/or based on activity or inactivity detected on the data flow.

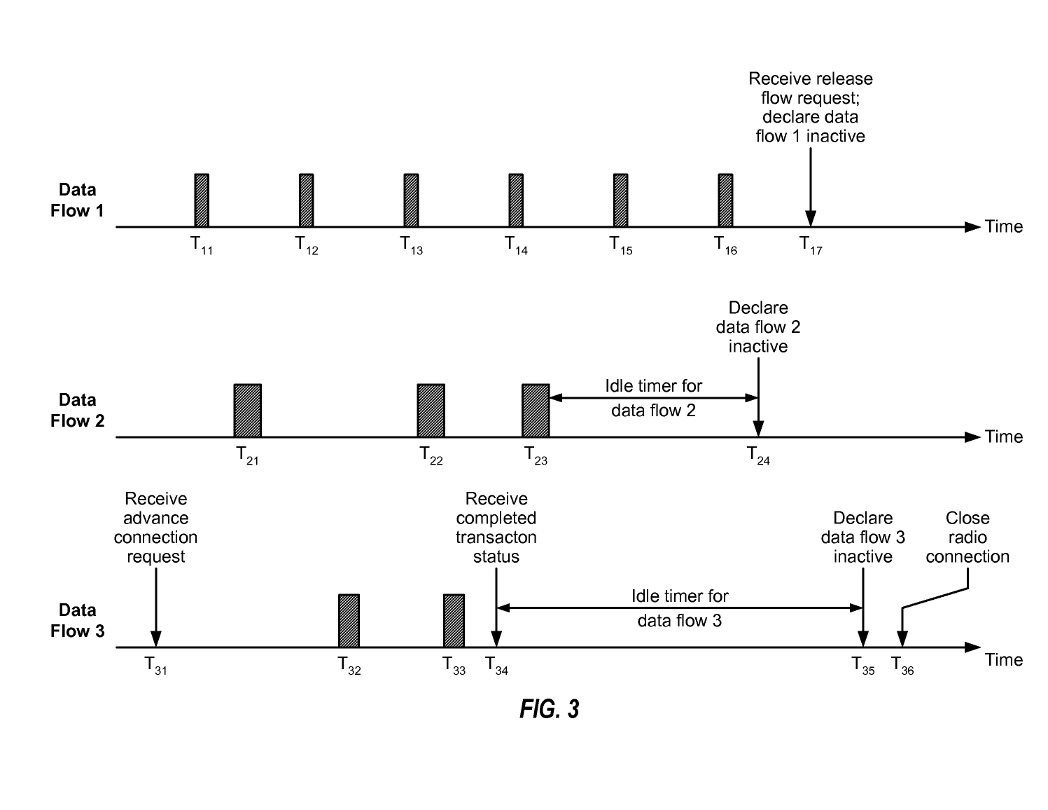

FIG. 3 shows an example of detection for end of activity for three data flows. In this example, data flow 1 may be an RTP flow that carries traffic data at regular intervals, e.g., every 20 ms for VoIP. Data flow 2 may be a SIP flow that carries signaling data sporadically and less frequently. Data flow 3 may be a best effort flow that carries traffic data sporadically, e.g., for text messaging. Activities on each data flow are shown by rectangular shaded boxes, where each box may represent a transaction that may correspond to reception and/or transmission of data.

In the example shown in FIG. 3, data flow 1 has the explicit release preference, and an idle timer is not maintained for data flow 1. Data is exchanged on data flow 1 at times T₁₁, T₁₂, T₁₃, T₁₄, T₁₅ and T₁₆. A release flow request is received for data flow 1 at time T₁₇, and data flow 1 may be declared as inactive and released at this point. From the perspective of data flow 1, the radio connection may be closed at time T₁₇ if no other data flows are active.

Data flow 2 has the idle release preference and an idle timer value of V₂. Transactions occur on data flow 2 at times T₂₁, T₂₂ and T₂₃. Although not shown in FIG. 3, the idle timer for data flow 2 may be started at the end of each transaction and may be canceled at the start of the following transaction. In the example shown in FIG. 3, the idle timer for data flow 2 may be started after the end of the transaction at time T₂₃ and may expire at time T₂₄, which is V₂ seconds from the end of the transaction at time T₂₃. Data flow 2 may be declared as inactive and released at time T₂₄. From the perspective of data flow 2, the radio connection may be closed at time T₂₄ if no other data flows are active.

Data flow 3 also has the idle release preference but an idle timer value of V₃. An advance connection request may be received at time T₃₁, and the radio connection may be established if it is not already up. Data flow 3 may be set up when the advance connection request is received of sometime thereafter. Transactions occur on data flow 3 at times T₃₂ and T₃₃. The idle timer for data flow 3 may be started at the end of each transaction and may be canceled at the start of the following transaction. In the example shown in FIG. 3, a completed transaction status is received at time T₃₄. The idle timer for data flow 3 may be started at time T₃₄ and may expire at time T₃₅, which is V₃ seconds from time T₃₄. Data flow 3 may be declared as inactive and released at time T₃₅. Since no data flows are active at time T₃₅, the radio connection may be closed at time T₃₅ or thereafter at time T₃₆.

As shown in FIG. 3, different flow preferences may be used for different data flows to allow for detection of inactive data flows as quickly as possible. Furthermore, different idle timer values may be used for different data flows and may be selected based on the characteristics and/or requirements of these data flows.

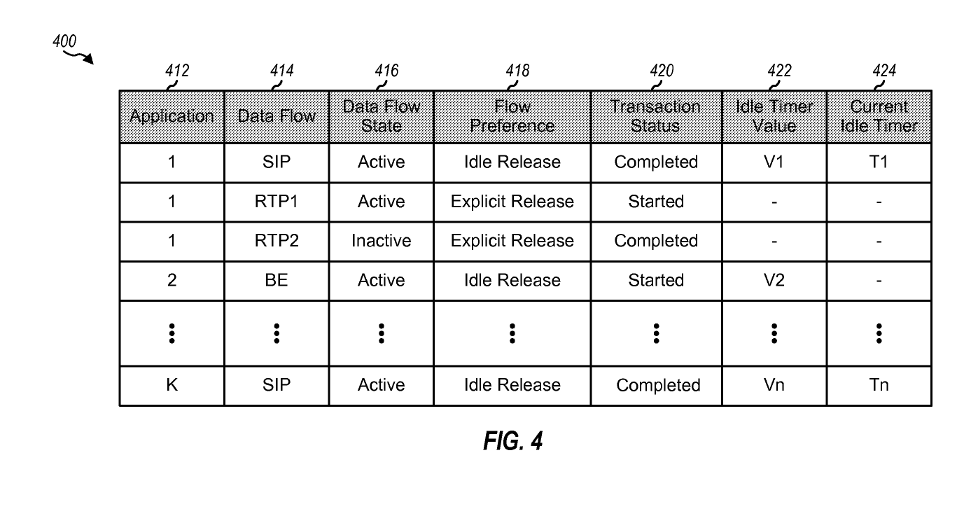

FIG. 4 shows a design of a data flow information table 400 that may be used to store pertinent information for data flows. In this design, table 400 includes one entry for each data flow. The entry for each data flow may include a field 412 for the application to which the data flow belongs, a field 414 for data flow ID and/or data flow type, a field 416 for the current state (e.g., active or inactive) of the data flow, a field 418 for the flow preference for the data flow, a field 420 for the status of the most recent transaction on the data flow, a field 422 for an idle timer value for the data flow, and a field 424 for the current value of the idle timer (if any) for the data flow. The idle timer related fields 422 and 424 may be applicable for data flows with the idle release preference. The fields for each data flow may be initialized and updated as described below. Table 400 may also include other pertinent information for the data flows.

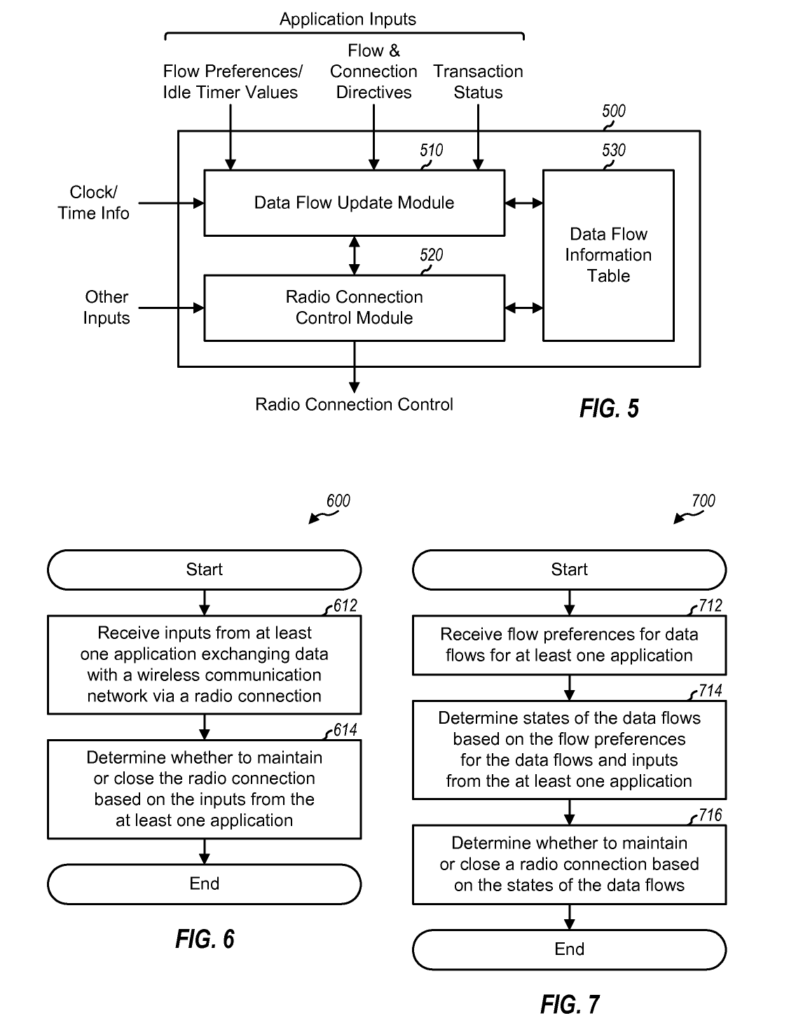

FIG. 5 shows a design of a module 500 that detects for end of activity and controls the radio connection based on inputs from the applications. Module 500 may be part of the protocol stack at access terminal 110. In this design, module 500 includes a data flow update module 510, a radio connection control module 520, and a data flow information table 530. Table 530 may be implemented in the same manner as table 400 in FIG. 4. Modules 510 and 520 may operate to decide whether to establish, maintain, or close the radio connection based on inputs received from the applications and the states of the data flows, as described below.

In the design shown in FIG. 5, the applications may provide inputs such as flow preferences and idle timer values (if applicable) for the data flows, flow and connection directives, and transaction status for the data flows. The applications may provide these inputs when the data flows are set up or released, when the characteristics and/or requirements of the data flows change, when transactions occur on the data flows, etc. Modules 510 may update table 530 based on the application inputs, and module 520 may control the radio connection based on table 530.

An application may provide a flow preference and possibly an idle timer value when a data flow is set up. Module 500 may create a new entry in table 530 for the data flow and may populate the fields of this entry with the inputs received from the application for the data flow. Module 500 may also initialize the state of the data flow as active.

An application may set up a data flow but may not provide information such as flow preference, idle timer value, transaction status, etc. In this case, module 500 may use a default flow preference (e.g., the idle release preference) and a default idle timer value (e.g., 30 seconds) for the data flow. The same default flow preference and/or the same default idle timer value may be used for all data flows. Alternatively, different default flow preferences and/or different default idle timer values may be used for different types of data flows (e.g., RTP, SIP, BE flows) or different types of applications (e.g., VoIP, data downloading, etc.).

An application may change the flow preference from idle release to explicit release for a data flow. Module 500 may update the flow preference for the data flow accordingly in table 530. Module 500 may also cancel the idle timer for the data flow, if it is started, so that the data flow will not be released automatically by expiration of the idle timer.

An application may change the flow preference from explicit release to idle release for a data flow. Module 500 may update the flow preference and the idle timer value for the data flow accordingly in table 530. Module 500 may start the idle timer for the data flow either immediately if its current transaction status is completed or later when the transaction status becomes completed.

An application may send transaction status of the most recent transaction for a data flow. If the data flow has the explicit release preference, then module 500 may simply record the transaction status in the appropriate field for possible use later. If the data flow has the idle release preference, then module 500 may (i) start the idle timer for the data flow if the transaction status is completed or (ii) cancel the idle timer if the transaction status is started. When the idle timer for the data flow expires, module 500 may update the state of the data flow to inactive.

An application may send a release flow request for a data flow, which may have the explicit release or idle release preference. Module 500 may update the state of the data flow to inactive.

An application may send an advanced connection request. Module 500 may then establish the radio connection if it is not already up. Module 500 may also set up a data flow and may then create a new entry in table 530 for the data flow. An application may send a close connection request. Module 500 may then close the radio connection if appropriate.

Module 500 may also update the states of the data flows based on other information. For example, if an application de-registers with SIP and/or some other protocol, then all data flows for the de-registered protocol(s) may be marked as inactive.

Module 510 may periodically evaluate the states of the data flows based on the application inputs and other inputs. For example, module 510 may update (e.g., advance) the idle timers for the data flows every T_{update} seconds, as indicated by time information received from a clock source. Module 510 may also update (e.g., start or cancel) the idle timers whenever activity or inactivity is detected and whenever transaction status is received. Module 510 may update the states of the data flows based on the idle timers and also whenever flow and connection directives are received.

Module 520 may determine whether to establish, maintain, or close the radio connection. Module 520 may establish the radio connection when a new data flow is set up, when an advance connection request is received, etc. Module 520 may keep the radio connection up if any data flow is active and may close the radio connection when all data flows are inactive. Module 520 may also consider other factors, besides the data flow states, in determining whether to establish, maintain, or close the radio connection. Module 520 may also re-establish the radio connection, as necessary, if it is released by the network or due to link error. Module 520 may provide a radio connection control to establish, maintain, or close the radio connection.

FIG. 6 shows a design of a process 600 for controlling a radio connection. Process 600 may be performed by access terminal 110. For process 600, inputs may be received from at least one application exchanging data with a wireless communication network (e.g., an HRPD network) via a radio connection (block 612). Whether to maintain or close the radio connection may be determined based on the inputs from the at least one application (block 614).

FIG. 7 shows a design of a process 700 for controlling a radio connection. Process 700 may also be performed by access terminal 110. For process 700, flow preferences may be received from at least one application for data flows, which may include SIP flows, RTP flows, etc. (block 712). The flow preferences may include (i) a flow preference to maintain a data flow until it is explicitly released, (ii) a flow preference to release a data flow after an idle time, and/or (iii) other flow preferences. A default flow preference may be used for a data flow if a flow preference is not received from an application for the data flow. The states of the data flows may be determined based on their flow preferences and inputs from the at least one application (block 714). For example, a data flow may be determined to be active or inactive based on its flow preference, inputs received from an application for the data flow, activity detected on the data flow, etc. Whether to maintain or close a radio connection may be determined based on the states of the data flows (block 716). For example, the radio connection may be closed when all of the data flows are determined to be inactive.

The flow preference for a given data flow may indicate to maintain the data flow until it is explicitly released. The state of the data flow may be set to active when the data flow is set up and to inactive when a release request (e.g., a release flow request or a close connection request) is received from an application for the data flow.

The flow preference for a given data flow may indicate to release the data flow after an idle time. The state of the data flow may be set to active when the data flow is set up and to inactive if no activity is detected on the data flow for an amount of time corresponding to the idle time. An idle timer value may be received for the data flow. An idle timer may be started with the idle timer value when a transaction is completed or inactivity is detected on the data flow. The state of the data flow may be set to inactive when the idle timer expires. The idle timer may be canceled if activity is detected or another transaction is started on the data flow. A default idle timer value may be used for the data flow if an idle timer value is not received from an application for the data flow.

A transaction status indicating a transaction is started on a given data flow may be received. An idle timer for the data flow may be canceled in response to this transaction status. A transaction status indicating a transaction is completed on the data flow may also be received. The idle timer may be started in response to this transaction status.

An advance connection request may be received to establish the radio connection prior to a data flow being set up. The advance connection request may be generated in response to typing activities on a keypad, other user activities, etc. The radio connection may then be established if it is not currently up. A request to close the radio connection may also be received from an application. Whether to close the radio connection may be determined in response to the close connection request.

The techniques described herein allow the applications to provide inputs to control the data flows as well as the radio connection to achieve the desired performance. The applications may request to set up data flows and/or establish the radio connection, as needed by traffic requirements. The applications may also request to release data flows and/or close the radio connection when no longer needed. Module 500 may consider the inputs from the applications, possibly along with other inputs from other sources, to manage the data flows and the radio connection.

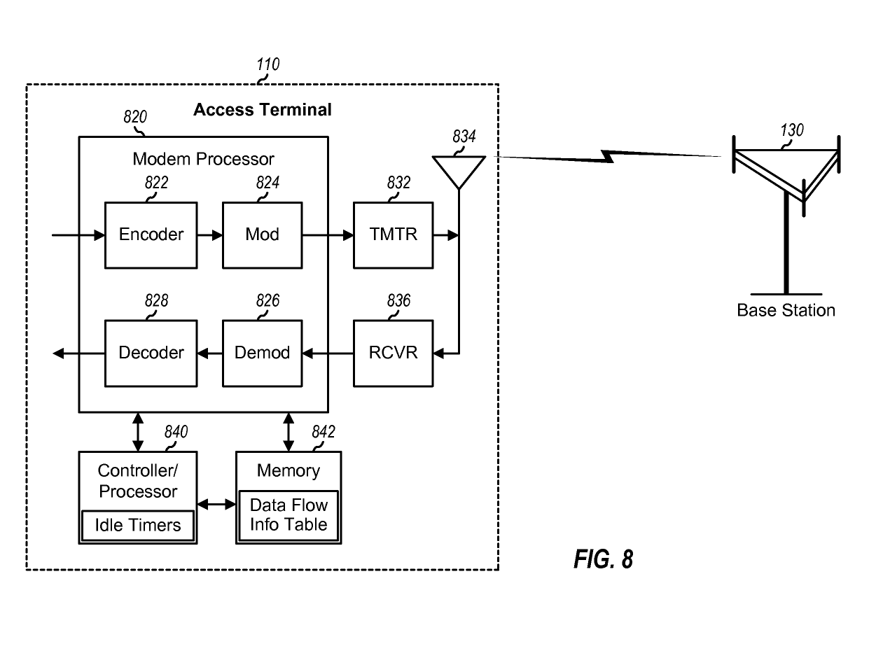

FIG. 8 shows a block diagram of a design of access terminal 110 in FIG. 1. On the reverse link (or uplink), data and signaling to be sent by access terminal 110 are processed (e.g., formatted, encoded, and interleaved) by an encoder 822 and further processed (e.g., modulated, channelized, and scrambled) by a modulator (Mod) 824 in accordance with an applicable radio technology (e.g., HRPD, 1X, W-CDMA, GSM, etc.) to generate output chips. A transmitter (TMTR) 832 then conditions (e.g., converts to analog, filters, amplifies, and frequency upconverts) the output chips and generates a reverse link signal, which is transmitted via an antenna 834.

On the forward link (or downlink), antenna 834 receives forward link signals transmitted by the base stations and provides a received signal. A receiver (RCVR) 836 conditions (e.g., filters, amplifies, frequency downconverts, and digitizes) the received signal and provides samples. A demodulator (Demod) 826 processes (e.g., descrambles, channelizes, and demodulates) the samples and provides symbol estimates. A decoder 828 further processes (e.g., deinterleaves and decodes) the symbol estimates and provides decoded data. Encoder 822, modulator 824, demodulator 826, and decoder 828 may be implemented by a modem processor 820. These units perform processing in accordance with the radio technology (e.g., HRPD, 1X, W-CDMA, GSM, etc.) being received. For example, demodulator 826 may perform descrambling with scrambling sequences, despreading with orthogonal codes, and data demodulation for HRPD, 1X, or W-CDMA.

A controller/processor 840 controls the operation at access terminal 110. A memory 842 stores data and program codes for access terminal 110. Controller/ processor 840 may implement process 600 in FIG. 6, process 700 in FIG. 7, and/or other processes to detect for end of activity and control the radio connection. Controller/processor 840 may also implement module 500 in FIG. 5 and idle timers for the data flows. Memory 842 may store information for the data flows, e.g., table 400 in FIG. 4.

The techniques described herein may be implemented by various means. For example, these techniques may be implemented in hardware, firmware, software, or a combination thereof. For a hardware implementation, the processing units used to perform the techniques may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, a computer, or a combination thereof.

For a firmware and/or software implementation, the techniques may be implemented with modules (e.g., procedures, functions, etc.) that perform the functions described herein. The firmware and/or software instructions may be stored in a memory (e.g., memory 842 in FIG. 8) and executed by a processor (e.g., processor 840). The memory may be implemented within the processor or external to the processor. The firmware and/or software instructions may also be stored in other processor-readable medium such as random access memory (RAM), read-only memory (ROM), non-volatile random access memory (NVRAM), programmable read-only memory (PROM), electrically erasable PROM (EEPROM), FLASH memory, compact disc (CD), magnetic or optical data storage device, etc.

An apparatus implementing the techniques described herein may be a stand-alone unit or may be part of a device. The device may be (i) a stand-alone integrated circuit (IC), (ii) a set of one or more ICs that may include memory ICs for storing data and/or instructions, (iii) an ASIC such as a mobile station modem (MSM), (iv) a module that may be embedded within other devices, (v) a cellular phone, wireless device, handset, or mobile unit, (vi) etc.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. An apparatus comprising:
a processor configured to receive inputs from at least one application exchanging data with a wireless communication network via a radio connection, and to determine whether to maintain or close the radio connection based on the inputs from the at least one application; and
a memory coupled to the processor.

2. The apparatus of claim 1, wherein the processor is configured to maintain states of data flows for the at least one application based on the inputs from the at least one application, and to determine whether to maintain or close the radio connection based on the states of the data flows.

3. The apparatus of claim 2, wherein the processor is configured to receive flow preferences for the data flows and to maintain the states of the data flows based on the flow preferences for the data flows and the inputs from the at least one application.

4. The apparatus of claim 2, wherein the processor is configured to determine whether each of the data flows is active or inactive based on inputs received from an application for the data flow, and to close the radio connection when all of the data flows are inactive.

5. The apparatus of claim 1, wherein the processor is configured to receive an advance connection request to establish the radio connection prior to a data flow being set up, and to establish the radio connection, if not currently up, in response to the advance connection request.

6. The apparatus of claim 5, wherein the advance connection request is generated in response to typing activities on a keypad.

7. The apparatus of claim 1, wherein the processor is configured to receive a request to close the radio connection from one of the at least one application and to determine whether to close the radio connection in response to the request.

8. The apparatus of claim 2, wherein the data flows comprise at least one Session Initiation Protocol (SIP) flow, or at least one Real-time Transport Protocol (RTP) flow, or both.

9. The apparatus of claim 1, wherein the wireless communication network is a High Rate Packet Data (HRPD) network.

10. A method comprising:
receiving inputs from at least one application exchanging data with a wireless communication network via a radio connection; and
determining whether to maintain or close the radio connection based on the inputs from the at least one application.

11. The method of claim 10, further comprising:
maintaining states of data flows for the at least one application based on the inputs from the at least one application, and
wherein the determining whether to maintain or close the radio connection comprises determining whether to maintain or close the radio connection based on the states of the data flows.

12. The method of claim 11, wherein the maintaining the states of the data flows comprises determining whether each of the data flows is active or inactive based on inputs received from an application for the data flow, and wherein the determining whether to maintain or close the radio connection comprises closing the radio connection when all of the data flows are inactive.

13. An apparatus comprising:
means for receiving inputs from at least one application exchanging data with a wireless communication network via a radio connection; and
means for determining whether to maintain or close the radio connection based on the inputs from the at least one application.

14. The apparatus of claim 13, further comprising:
means for maintaining states of data flows for the at least one application based on the inputs from the at least one application, and
wherein the means for determining whether to maintain or close the radio connection comprises means for determining whether to maintain or close the radio connection based on the states of the data flows.

15. The apparatus of claim 14, wherein the means for maintaining the states of the data flows comprises means for determining whether each of the data flows is active or inactive based on inputs received from an application for the data flow, and wherein the means for determining whether to maintain or close the radio connection comprises means for closing the radio connection when all of the data flows are inactive.

16. An apparatus comprising:
a processor configured to receive flow preferences for data flows for at least one application, to determine states of the data flows based on the flow preferences for the data flows and inputs from the at least one application, and to determine whether to maintain or close a radio connection based on the states of the data flows; and
a memory coupled to the processor.

17. The apparatus of claim 16, wherein a flow preference for a data flow indicates to maintain the data flow until explicitly released, and wherein the processor is configured to set the state of the data flow to active when the data flow is set up and to set the state of the data flow to inactive when a release request is received from an application for the data flow.

18. The apparatus of claim 16, wherein a flow preference for a data flow indicates to release the data flow after an idle time, and wherein the processor is configured to set the state of the data flow to active when the data flow is set up and to set the state of the data flow to inactive when no activity is detected on the data flow for an amount of time corresponding to the idle time.

19. The apparatus of claim 18, wherein the processor is configured to receive an idle timer value for the data flow, to start an idle timer with the idle timer value when a transaction is completed or inactivity is detected on the data flow, and to set the state of the data flow to inactive when the idle timer expires.

20. The apparatus of claim 19, wherein the processor is configured to cancel the idle timer if activity is detected or another transaction is started on the data flow.

21. The apparatus of claim 19, wherein the processor is configured to use a default idle timer value for the data flow if an idle timer value is not received from an application for the data flow.

22. The apparatus of claim 18, wherein the processor is configured to receive a transaction status indicating a transaction is started on a data flow and to cancel an idle timer for the data flow in response to receiving the transaction status.

23. The apparatus of claim 18, wherein the processor is configured to receive a transaction status indicating a transaction is completed on a data flow and to start an idle timer for the data flow in response to receiving the transaction status.

24. The apparatus of claim 16, wherein the processor is configured to receive a change in flow preference for a data flow and to determine the state of the data flow based on the change in flow preference.

25. The apparatus of claim 16, wherein the processor is configured to use a default flow preference for a data flow if a flow preference is not received from an application for the data flow.

26. A method comprising:
receiving flow preferences for data flows for at least one application;
determining states of the data flows based on the flow preferences for the data flows and inputs from the at least one application; and
determining whether to maintain or close a radio connection based on the states of the data flows

27. The method of claim 26, wherein the receiving the flow preferences for the data flows comprises receiving a flow preference for a data flow indicating to maintain the data flow until explicitly released, and wherein the determining the states of the data flows comprises
setting the state of the data flow to active when the data flow is set up, and
setting the state of the data flow to inactive when a release request is received from an application for the data flow.

28. The method of claim 26, wherein the receiving the flow preferences for the data flows comprises receiving a flow preference for a data flow indicating to release the data flow after an idle time, and wherein the determining the states of the data flows comprises
setting the state of the data flow to active when the data flow is set up, and
setting the state of the data flow to inactive when no activity is detected on the data flow for an amount of time corresponding to the idle time.

29. An apparatus comprising:
means for receiving flow preferences for data flows for at least one application;
means for determining states of the data flows based on the flow preferences for the data flows and inputs from the at least one application; and
means for determining whether to maintain or close a radio connection based on the states of the data flows

30. The apparatus of claim 29, wherein the means for receiving the flow preferences for the data flows comprises means for receiving a flow preference for a data flow indicating to maintain the data flow until explicitly released, and wherein the means for determining the states of the data flows comprises
means for setting the state of the data flow to active when the data flow is set up, and
means for setting the state of the data flow to inactive when a release request is received from an application for the data flow.

31. The apparatus of claim 29, wherein the means for receiving the flow preferences for the data flows comprises means for receiving a flow preference for a data flow indicating to release the data flow after an idle time, and wherein the means for determining the states of the data flows comprises
means for setting the state of the data flow to active when the data flow is set up, and
means for setting the state of the data flow to inactive when no activity is detected on the data flow for an amount of time corresponding to the idle time.

32. A processor-readable media for storing instructions to:
receive flow preferences for data flows for at least one application;
determine states of the data flows based on the flow preferences for the data flows and inputs from the at least one application; and
determine whether to maintain or close a radio connection based on the states of the data flows

33. The processor-readable media of claim 32, and further for storing instructions to:
receive a flow preference for a data flow indicating to maintain the data flow until explicitly released,
set the state of the data flow to active when the data flow is set up, and
set the state of the data flow to inactive when a release request is received from an application for the data flow.

34. The processor-readable media of claim 32, and further for storing instructions to:
receive a flow preference for a data flow indicating to release the data flow after an idle time,
set the state of the data flow to active when the data flow is set up, and
set the state of the data flow to inactive when no activity is detected on the data flow for an amount of time corresponding to the idle time.
